(19) United States
(12) Patent Application Publication
(10) Pub. No.: US 2005/0125717 A1
(43) Pub. Date: Jun. 9, 2005

(54) System and method for off-line synchronized capturing and reviewing notes and presentations

(76) Inventors: Tsakhi Segal, Cupertino, CA (US); Liel Biran, (US); Giora Feldman, (US); Guy Krikheli, (US)

Correspondence Address: GLENN PATENT GROUP, 3475 EDISON WAY, SUITE L, MENLO PARK, CA, 94025, US

(21) Appl. No.: 10/977,257

(22) Filed: Oct. 28, 2004

Related U.S. Application Data
(60) Provisional application No. 60/515,121, filed on Oct. 29, 2003.
(60) Provisional application No. 60/534,683, filed on Jan. 8, 2004.
(60) Provisional application No. 60/580,706, filed on Jun. 21, 2004.

(51) Int. Cl. G06F 17/00

(52) U.S. Cl. 715/512

(57) ABSTRACT

The system and methods teach the capturing of notes in synchronization to a presentation, or any other form of message delivery, that enables the synchronized review between the presentation and notes made thereof. A synchronization between the presenter's and note taker's clocks through a time server allows for the off-line note taking using a plurality of note taking devices while maintaining synchronization. Due to this off-line synchronization between a presentation and notes taken thereof it is possible to easily locate both the note taken at a certain time in the presentation and vice versa, making notes relevant to a portion of the presentation when they were taken.

### CROSS REFERENCE TO RELATED APPLICATIONS

This application takes priority from U.S. provisional patent application 60/515,121 filed Oct. 29, 2003, U.S. provisional application 60/534,683 filed Jan. 8, 2004, and U.S. provisional application 60/580,706 filed Jun. 21, 2004.

### BACKGROUND OF THE INVENTION

1. Technical Field

The invention relates generally to the fields of presentations and note-taking by participants in presentations. More particularly, the invention relates to synchronization of note-taking with a presentation.

2. Discussion of the Prior Art

Students and corporate employees commonly engage in writing notes during presentations, e.g. during classes or meetings. Notes, which may take the form of written text, drawings, shorthand symbols, and more, serve the purpose of enhancing memory recall and of documenting the class or meeting. Notes may be reviewed later on for many uses, including for example, preparation for exams or follow-up meetings, and to research or act upon information conveyed in the presentation. Typically, such notes provide a way for a participant in a presentation to summarize important points and indicate subject matter that requires further research or action.

Despite the note-takers intentions, notes often prove to be of limited use. This is especially true of hard-copy notes on paper, which are difficult to access and search. However, even when using modern computer applications that specialize in note storage and retrieval, the usability of notes is limited due to loss of context. A note that may have made perfect sense within the context of a presentation often seems meaningless after several days or weeks have passed and crucial information connecting the note to the content of the presentation is not readily accessible. The cause of this problem is that notes are collected and stored by participants on personal media, whether hard-copy or computer based, that is not usually associated with a recorded rendition of the presentation, either because it is not recorded at all or because the recording is not readily accessible.

One practical solution is to record presentations, for instance as online multimedia content, such as those produced by means disclosed in U.S. Pat. No. 6,388,654 entitled “Method and Apparatus for Processing, Displaying and Communicating Images” (hereinafter the “Tegrity Software Application” or “TSA”) assigned to a common assignee and which is herein incorported by this reference thereto for all that it contains. It is possible to provide access to such recordings, allowing participants to play back a selected presentation while reviewing the relevant notes made in a paper notebook or note-storing computer application. The main drawback of this approach is the lack of direct access between a note taken during a presentation and the location on the multimedia content that pertains to that location. To locate the portion of a presentation pertaining to a particular note, one must spend time locating the correct recording e.g. tape, CD, link, or other media, and then search for the appropriate segment within it by, for example, playing back the recording sequentially, perhaps skipping forward or backward until the desired portion is found. Similarly, while playing back a portion of a recorded presentation, there is no easy way to locate and identify the notes originally made at that point in the presentation. When using shorthand symbols or abbreviated markings, context may be irrecoverably lost once human memory of the event and the cause for making the notation fades. At the extreme, this could require a participant to review the entire recorded presentation to recapture the meaning of a single shorthand note that was made while attending the original event. The same drawback applies to new notes that may be made subsequently during sequential reviews of such recordings.

Certain prior art solutions suggest that a system be made where note taking is done while the note taking devices are kept in constant synchronization with the presentation, i.e. the presenter's computer as well as the note takers' note taking devices are all on line and fully synchronized with the presenter's presentation. This requires network connectivity at all times for all computerized note taking devices, significantly limiting the practicality of such systems.

It would be therefore advantageous to provide a method and apparatus for note taking that is synchronized with a presentation without requiring active network connectivity while note taking takes place.

### SUMMARY OF THE INVENTION

The invention herein comprises the capturing of notes in synchronization to a presentation, or any other form of message delivery, in a manner that enables the synchronized review between the presentation and notes made thereof. Synchronization between the presenter's and note taker's clocks through a time server allows for the off-line note taking using a plurality of note taking devices while maintaining synchronization. Due to this off-line synchronization between a presentation and notes taken thereof it is possible to easily locate both the note taken at a certain time in the presentation and vice versa, making notes relevant to a portion of the presentation when they were taken.

### BRIEF DESCRIPTION OF THE DRAWINGS

FIG. 1 illustrates a presentation as it appears on a page of a note taker's notebook application according to the invention;

FIG. 2 illustrates notes written by a note taker on a notebook page that are both adjacent to and overlapping an image imported into a notebook application, as well as annotations made by a presenter according to the invention;

FIG. 3 illustrates a notebook page that contains an imported slide-image along with note taker notes and an iconic indication inserted by the note taker according to the invention;

FIG. 4 shows a notebook application side-by-side with a presentation viewing application as seen during review after a presentation where playback is positioned two seconds into the presentation according to the invention;

FIG. 5 illustrates presentation of FIG. 4 after playback has shifted 30 seconds to 0:32 as a result of activating indexed playback on a selected iconic indication according to the invention;

FIG. 6 illustrates the presentation of FIG. 4 with notes highlighting during playback shifted an additional 33 seconds to 0:55 according to the invention;

FIG. 7 a flowchart showing a method for capturing notes and arranging them according to this invention;

FIG. 8 is a block schematic diagram of a system to this invention;

FIG. 9 is a flowchart showing a clock synchronization process according to the invention.

### DETAILED DESCRIPTION OF THE INVENTION

The following terms are used throughout this disclosure. Unless explicitly noted otherwise, wherever these terms are used they refer to the meanings assigned below:

Presentation—a class lecture, meeting, training session, or any human interaction convened for the purpose of conveying information. A presentation comprises a presenter and one or more note takers (defined below). Each presentation captured for use with a deployment of this invention is assigned a unique ID to distinguish it from other collocated presentations.

Presenter—the person or persons conveying presentation information to others in a presentation. The presenter may comprise one or more individuals at any given time and presenters may change or alternate during the presentation.

Presentation information—any material that is referenced or linked to the presentation and can be accessed electronically, including, but not limited to, verbal or otherwise audible information (audio), visual information (video), notes, slides or other images, at which the presenter may point, computer applications, textbooks, articles, and web pages.

Note taker (or Participant)—an individual attending a presentation with the intent of obtaining information. A note taker may be physically present at the site where the presentation takes place or may attend via means of communication from a remote site. A note taker may also become a presenter during a portion of a presentation or, throughout the presentation may be a presenter.

Notes—information entered by a note taker into an application, for example, a computer application with data entry capabilities, such information pertaining to a presentation. The information may be entered to the application, on-line or off-line, by means that include, but are not limited to, handwritten digital ink, text, selectable predefined symbols (icons), images, or any other computer-based object that may be inserted in a application.

Notebook application (or notebook)—a computer software application that provides capabilities for entering notes. Typically, a notebook includes many features that aid in organizing, entering, and reviewing notes for personal use, such as multiple sections, multiple notebook files, options for inserting and formatting notes, options for selecting notes in order to copy, move, delete or reformat them, and more. Regardless of additional hierarchical organization that may be available, the notebook's most basic working area is referred to as a page, where each page may contain multiple notes. The precise boundaries of a page depend on the specific notebook application, and may be based on a fixed or modifiable display size or may be determined by explicit actions of the user, e.g. via “add/insert page” functionality. For the purposes of this description a notebook section is a logical unit of information in which the notes for a single presentation are kept. Depending on the notebook application, each section may be implemented as a separate data file or container, as a hierarchical construct within a single notebook container, or only as a logical entity based on assigning a section attribute or tag internal to the notebook application. The invention may be implemented to work with various distinct notebook applications running on desktop and portable computing devices, including portable computers, handheld devices, such as Palm Pilot® and Pocket PC®, or any device capable of supporting such applications. Examples of existing notebook applications include products from the Microsoft Office® suite and internet browser applications that support plug-in modules and extensions which may add notebook functionality.

Synchronous—happening at real-time. When referring to a presentation this indicates that the note takers receive information from the presenter as it is conveyed during the presentation, possibly with a small delay. Note takers may be physically present at the same site as the presenter or in remote locations, but they are communicating in the same time frame.

Asynchronous—not synchronous. When referring to a presentation this indicates that note takers receive information from the presenter after it has been conveyed, perhaps long after the presentation is over. This is accomplished by playing back a recorded rendition of the presentation by some means. The note taker may be at any location during asynchronous playback.

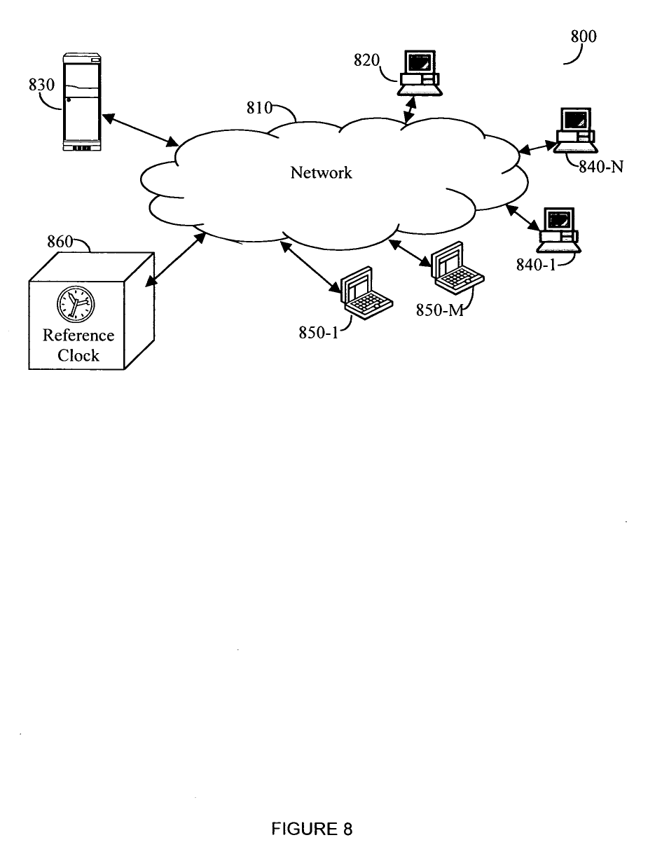

The invention comprises an apparatus and method for enhancing the process of capturing and reviewing notes by note takers in presentations, to provide for more efficient information retrieval and to facilitate more effective learning. The invention may be further understood in conjunction with the system 800 shown in FIG. 8, which is an exemplary and non-limiting system for the realization of the disclosed invention. A goal of the invention is to provide note takers, for example those note takers using notebooks and other handheld devices 850-1 through 850-M, and note takers using computers, for example computers 840-1 through 840-N, with means to create useful -notes regardless of whether they are physically present at the presentation. The presentation is made by a presenter using, for example, a computer 820. The note takers may alternatively be at remote locations, as made possible by connectivity with a network 810. Notes may be taken regardless of whether the notes are taken before the presentation in preparation, during the presentation, or after the presentation while performing a review, for example by means of downloading the presentation, or otherwise viewing the presentation, from a server 830. Note taking in accordance with the invention is synchronized to a presentation regardless of the connectivity of the device used to enter the notes, i.e. it may be on-line or off-line, while assuring note synchronization with the presentation. Namely, physical synchronization is performed only periodically, while at all other times at least devices 840 and 850 may be off-line. While the presenter is shown using computer 820, it is within the scope of the invention for the presenter to use other devices that are capable of synchronization in the manner disclosed herein, including but not limited to a voice recorder device or an audio-video recorder with a synchronized clock. The presenter may later import the recorded audio to a computer, subsequently generating the Tegrity software application (TSA) presentation that is later viewed by the note takers. In this case, there may be only audio or audio-video playback possibly while showing a slide containing general information about the presentation. The computer 820 or other device used by the presenter may likewise be either on-line or off-line during the presentation, while assuring synchronization with notes taken by note takers. Physical synchronization may be performed only periodically. On-line connectivity is normally required at certain times for the purposes of publishing presentation information to be accessed by note takers, however not necessarily during the presentation.

Another goal of the present invention is to allow note takers to use existing industry-standard note-taking hardware and software applications for any or all of their notes, while providing the enhanced capabilities afforded by the invention in connection with a subset of presentations i.e. those that are recorded according to the invention.

The invention may be implemented to empower a given notebook application with the functionality described herein, in addition to its own native functionality. An advantage of the invention is that the notebook application can be a commonly available, industry-standard software product, which note takers might be expected to use on a daily or periodic basis for much or all of their note-taking tasks, including presentations that do not make use of the current invention. It may also operate with specialized notebook applications developed to support hardware platforms for which no suitable standard applications exist.

Furthermore, the invention makes it possible to take notes before, during, and after the presentation in synchronization to the presentation, but without requiring a continued connection. This is accomplished in accordance with the disclosed invention by synchronizing periodically at least the note taking device and the presenter's device to a standard clock, for example a time-server 860, and thereafter maintaining a clock in reference to the standard clock, for the presentation as well as the note taking, as described in more detail below. The time-server 860 may be, for example, one of the time-servers available for access through the worldwide web. A time-server maintains a globally accurate time and external systems can access this information using a special Internet protocol, such as a network time protocol (NTP), or a simple network time protocol (SNTP), or the time-server may comprise a server configured to provide the information using a hyper text transfer protocol (HTTP). The time-server 860 can be also a specific designated computer including a reference clock.

For a given application, for example a notebook application, the invention can be carried out by implementing at least one software module that interacts with the notebook application and with one or more other applications, including multimedia presentation and control tools. Henceforth these software modules are referred to collectively as the notes module. The notes module may compare plug-ins, add-ins, or various types of executables, whether integrated with the notebook application or external to it. The notes module may interact with the notebook application by means of facilities built-in to that application, such as macros, or add-ins that execute in the context of the application. Alternatively, in the case of external modules, they may use software hooks offered by the underlying operating system or low-level drivers e.g. mouse and keyboard device drivers or display memory, to analyze activity and deduce what note-taking or control actions are required, based on what the note taker has done. Interaction with other tools i.e. presentation tools and control tools, can be implemented by various forms of inter-process communication within the same computer or over a network.

The notes module may also interact with external devices that collect or manage notes. This includes, but is not limited to, communicating with such devices over wired or wireless communication channels, and transferring data from and/or to the devices. This facilitates importing notes that were previously or concurrently collected by a note-taking device, exporting notes to a remote device, or exchanging management information about notes. As a non-limiting example, the Mobile Note Taker® device by Pegasus Technologies Ltd. may be used to collect and store a digital copy of handwritten notes while being written on paper with a pen. These notes can be imported into the notes application in real-time, i.e. while being written, or at a later time by connecting the device to a computer. The connection event activates software that is capable of extracting the digital note information e.g. point data and time values, and converting the information to the same internal representation as that which is used for notes entered using other means.

The notes module can also supply user-interface elements, such as toolbars, buttons, dialog boxes, data-entry fields, formatted displays, and more, to support the functions described herein and to allow the user to adapt, tune, or customize specific aspects of behavior. The user interfaces may be implemented with any of a great variety of appearances and options using well-known techniques.

In a presently preferred embodiment of the invention the notes module comprises VisualBasic add-in components and loaded executable files (DLLs) developed to work with Microsoft Office® products. In addition, to support some handheld devices, e.g. Palm Pilot®, Mobile Note Taker®, a specialized notebook application can be used with facilities to import and export pertinent data to another computer.

In preparation for a presentation, the presenter may publish material in the form of digital media, such as slides or documents, making them available to note takers via email, digital storage media, online e.g. internet or intranet over a network 810, through an organizational learning management system (LMS) or by other means. Note takers may subsequently insert this material as one or more objects in their notebook application. This allows them to prepare for the presentation and may also serve as a background for note-taking before, during or after the presentation by annotating over the objects visible in the notebook. This capability consists of locating the published material, selecting the objects to insert and inserting them in the notebook, and optionally resizing or reformatting their visual appearance. If a presenter plans to use a computer-based presentation application, for example on computer 820, to capture and stream or broadcast content from the presentation over a network, for example a network 810, using multimedia technologies, the material published by the presenter could also include a link or location at which note takers are able to access the presentation for online viewing when it occurs.

The note taker acquires published material through the notes module, which offers a user-interface that the note taker uses to browse to the location of the published material, to view a list of the material that the presenter has published, and to choose which items to insert in the notebook. If no material was formerly inserted into the notebook for this presentation, a new notebook section associated with the specific presentation may be automatically generated. Alternative ways of associating notebook sections and presentations are discussed below. Inserted items may be basic object types that conform to native formats of the notebook application: typical examples are images or text. They may also be of more complex forms, which may be implemented as, for example, Windows® COM or plug-in objects. Display formatting options for various types of objects are typically provided by the hosting notebook application, for example on a notebook 840 or a computer 850, and can be readily supplemented.

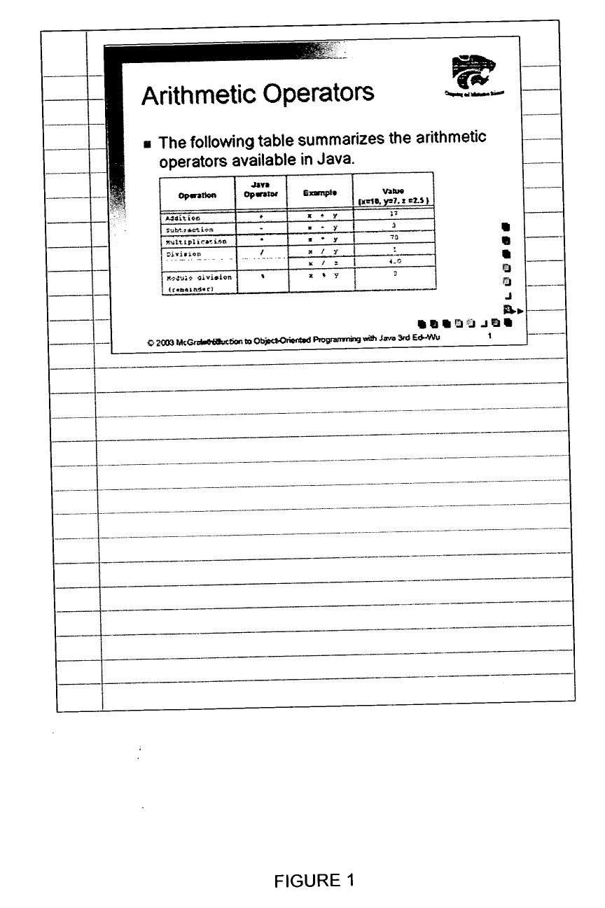

In one embodiment of the invention, the presenter uses the TSA to broadcast and record the presentation. In this case, the presenter uses an upload option offered by the TSA prior to the presentation to store a link on a server computer, along with media and other files associated with the planned presentation, such as a collection of slides and more. Note takers can access this link over the network to obtain relevant data in advance of or during, the presentation and to view the presentation once it begins. FIG. 1 provides an example of how such information may appear in a note taker's notebook once imported. FIG. 1 shows the image of a slide inserted at the top portion of an empty page.

Acquiring presentation materials can also be used to provide the note taker's notebook and notes module with general information about the presentation, such as title, name of presenter, organizational information, scheduling information and more. These items are would be stored in association with the appropriate notebook section for presentation. This information may be useful to the note taker and may aid, for example, in organizing notebooks, automatically starting the note-taking application at a scheduled time, and providing additional context for reviewed notes as described later on.

The events of starting and ending a presentation are relevant in two regards. The first is associating a specific presentation with the corresponding notebook section or notes object in the notebook of each note taker and the second is in synchronizing clocks. The specific options available to note takers depends mainly on network connectivity and whether or not a presentation capture tool is used. Note takers that are connected to a network, e.g. via wireless access, can benefit from automatic start/stop and synchronization with a presentation capture tool. This can be accomplished by communicating the event (start, stop) to the notes module, which modifies the notebook section. For a start event the modules creates a new section, if necessary, and associates it with the presentation being started by a unique presentation ID generated by the presentation capture system. For a stop event, closes the section. The start event can also set a presentation base-time value to be used in conjunction with time stamping all subsequent events for this presentation. Typically, the note taker is asked to confirm or deny participation in the presentation using a dialog-box type user-interface. If a section, was previously associated with the presentation, e.g. by acquisition of published materials, this section is used (opened) rather than creating a new one. The existence of a section can be accomplished by checking if any existing section is already associated with the unique presentation ID assigned to a presentation. The event and timing information could instead or in addition be communicated from a presentation viewing tool running on the note taker's computer. For example, the notes module may communicate directly with a viewer of a TSA component if one is running concurrently on the note taker's computer, or with a remote server component otherwise, to obtain this information.

All pertinent events that occur on the systems of presenter and on note-takers are time-tagged. For a presenter system events include, but are not limited to, the start (beginning) and stop (ending) of a presentation, pausing, resuming, slide changing, and bookmark creation. For a note-taker's system the events include, but are not limited to, insertion of a note, an iconic indication, or any other object related to a note. Time tags (or timestamps) are numeric values based on coordinated universal time (UTC) which is the same as Greenwich Mean Time (GMT). Computer clocks may not be set to the accurate time and each clock is limited in its precision, typically to 5-15 seconds a day. For that reason, it is important that all the UTC timestamps be synchronized to a common time server.

Each computer has a system-wide clock, also known as a system clock, which a user may view and change. During the act of synchronizing to the time server the system clock is adjusted so that timestamps are subsequently obtained directly from it, however, this is not required. Instead, in accordance with the invention an offset value is stored. This offset value allows the effective computing of a UTC timestamp from a system clock value, as described in greater detailed below.

Unlike prior art that synchronizes the presenter's system and note-takers' systems to each other online, the invention maintains reasonable synchronization without requiring a constant, active connection. Specifically, the systems of the presenter and note-takers are not required to communicate with each other, nor with any other systems during the presentation. The presenter system and all note-takers' systems communicate with the time-server 860 periodically for the purpose of synchronization, a process described herein below.

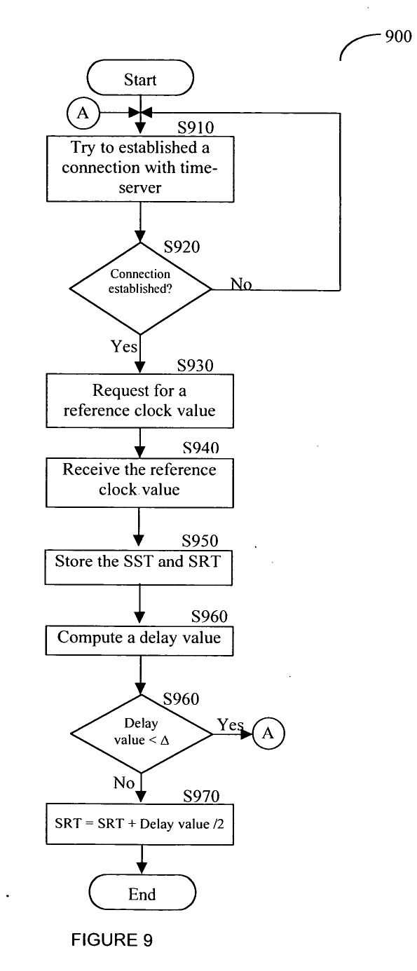

Referring to FIG. 9, a non-limiting flowchart 900 describing the clock's synchronization process is shown. Each of the handheld devices 850, computers 840, or computer 820, used by the presenter or the-note-takers, and collectively referred to herein as synchronization clients, executes the synchronization process. At step S910, each synchronization client periodically tries to connect to the time-server 860. This step is performed at pre-configured time intervals or whenever the computer is turned on. At step S920, a check is made to determine if a communication with the time-server 860 was established and, if so, execution continues with step S930. Otherwise, execution returns to step S910. At step S930, a request is sent to time-server 860 requesting the current value of the reference clock. At step S940, the time-server 860 responds with the desired value and subsequently, at step S950, the time values are stored. Specifically, two time values are kept: a stored system time (SST) and a stored reference time (SRT). The SST is the system clock value of the synchronization client at time of synchronization. This time is read after receiving the server's response. The SRT is the reference clock value (UTC) at time of synchronization as designated in the response. At step S960, the delay between the time that the request was sent and the time that the response received is measured, to reduce inaccuracy results from communication delays. At step S970, a check is made to determine as to whether the computed delay is less than a pre-configured value (Δ). If so, half of the computed delay value is added to the SRT. Otherwise, the synchronization process is unsuccessful and execution returns to step S910, while restoring the SST and SRT values to their previous values.

Upon completion of the synchronization process, the computed SRT and SST values are used to derive a UTC timestamp. This is performed using the equation:
CRT=CST+SRT−SST (1)
where CRT is the current reference time and CST is the current system time.

It should be noted that the CST is vulnerable to changes by the user or a third party application, and thus results in an inaccurate timestamp value. To avoid this, the system clock is always monitored. This is performed by tracking a message generated by the operating system (OS) that notifies that the system clock was changed, for example, the WM_TIMECHANGE message generated by Microsoft Windows. Another option for monitoring changes in the system clock is by comparing the CST to the tick-count. The tick-count value represents the number of milliseconds since the synchronization client system was first started. This value is read and stored in the system's memory. Periodically, the CST and tick-count values are read and compared to each other. If both clocks have advanced equally, then no change has occurred. Otherwise, the amount that the CST has advanced is accumulated into a stored value, referenced to as the advanced system time (AST). The AST is set to zero each time the SRT and SST values are stored. Therefore, a correct UTC timestamp for any event may be computed by the following equation:
CRT=CST+SRT−SST−AST. (2)

Alternatively (or in addition), the note taker could be allowed to create new sections manually and/or associate them with presentations before, during, or after the presentation by use of a presentation browsing and selection user-interface. The association can also be done by, or be assisted by, an automatic search through a collection of recorded presentations on specific servers, and selection of the one (or listing of those) that match appropriate criteria, among them the date and time-span in which the presentation took place. If clocks are not synchronized by either on-line or off-line approaches as described above, there remains the need to obtain a presentation base-time for proper synchronization. At least two additional options may be included to address this issue. One option is to allow note takers to correct the synchronization error after the presentation by shifting the time-frame values stored for the presentation while reviewing notes (described later). The second option is to have the notes module offer note takers a user interface, for example a button or recognizable pen gesture, that they can use when the presentation begins to reset the clock of the presentation, i.e. to indicate its starting time. The presenter is expected to notify participants when to activate this, for example by saying: “I'm starting now.” Presentation capture is expected to start simultaneously as well by the presenter or an assistant. A similar arrangement can be used to stop the presentation. However, this is not strictly necessary because all timestamps beyond the end of the captured presentation can easily be ignored or otherwise dealt with automatically while reviewing the presentation later on.

The various synchronization options are easily implemented by a commonly applied user interface and communication techniques while storing a UTC timestamp for each note or storing an offset or base time per notebook section i.e. per presentation on each note taker's computer, that can be set and adjusted as needed (internally and/or by the user) and to which all timestamps associated with that notebook section refer (via addition or subtraction) to produce timestamps that lie within the presentation time-frame, i.e. timestamps that are relative to the start of the presentation. Specifically, with current real-time clocks of personal computers and other note taking devices, their internal real-time clocks are accurate to 5-15 seconds a day. Therefore, it is not necessary to maintain an accurate, or on-line synchronization, at all times during the presentation. In accordance with the disclosed invention, the notebooks 850, computers 840 and 820, and the server 830 may synchronize clocks with a reference clock of a time server, for example time server 860, on a periodical basis, for example once every two days. At worst case this gives an accuracy of 30 seconds, sufficient for all practical matters. As computer clocks become more accurate it will be possible to delay clock synchronization for longer periods of time. This would free note taking from the need to maintain on-line connectivity with the presenter's presentation and allow the taking of notes in an of-line but synchronized manner. This is of particular importance in lecture rooms where a computer-based presentation is provided, but no network equipment is available to note takers.

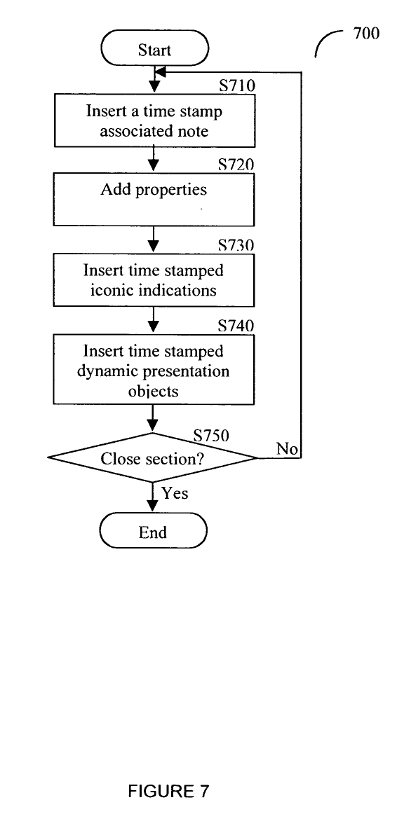

Referring to FIG. 7, a non-limiting flowchart describing the method for capturing notes and arranging them in accordance with an exemplary embodiment of the invention is shown. This method can be executed after the event of starting is received, the clocks were synchronized, and the presentation base-time value is set, either during the presentation or after it while reviewing notes.

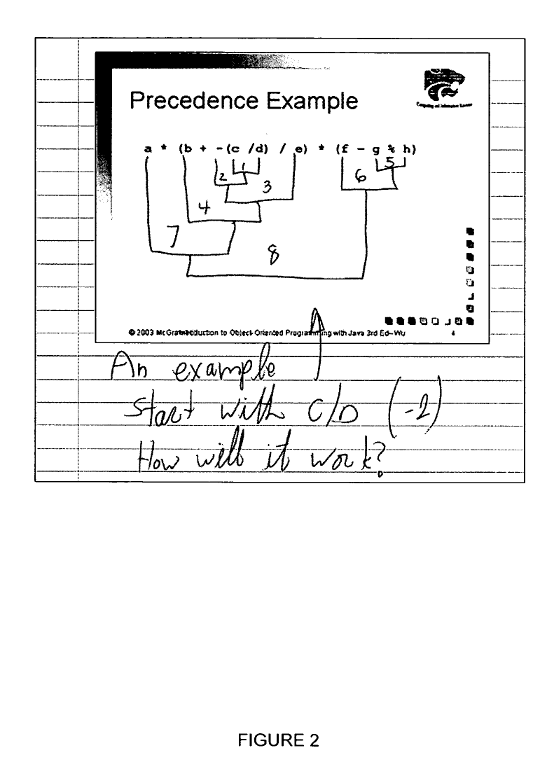

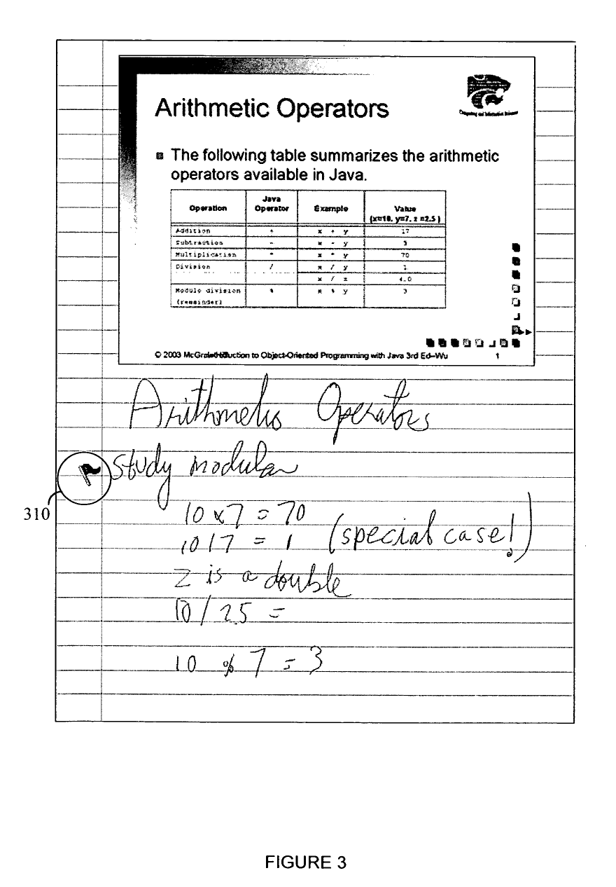

At step S710, each note taker may enter time stamped notes in a notebook section before, during, or after the associated presentation. Notes may be inserted over an area on a page that has an empty background or with partial or full overlap over visible objects inserted in the notebook prior to or during the presentation. For example, a student in a lecture may scribble hand-written notes using digital ink in the notebook application running on a portable tablet-based computer such as a TabletPC. The student may have previously inserted an image of one of the instructor's slides and may now annotate over it, adjacent to it, or both. For example, a note taker may draw an arrow that points into the slide image while adding a written comment outside that area at the other end of the arrow as shown in FIGS. 2 and 3. While these figures show note taking where a slide from a presenter is included, this should not be understood as limiting the scope of the invention. Specifically, note taking may be performed regardless of whether a presentation is included or not as part of the note taking. The student may further type text and insert additional objects, for example, subsequent slide images published by the instructor, if they are accessible either locally or via a network, and then annotate them in a like fashion. For the most part, these capabilities are provided by the underlying notebook application. The time stamp includes at least the current date and time, synchronized as explained in more detail above, and as obtained from the note taker's computer. The time stamp is not required to be in on-line synchronization with a time server, for example the time server 860, which is particularly convenient when a note-taker is taking the notes while the note taking device is off-line. This can usually be accomplished by adding a property or tag to newly added data, which is detected either by event notification or by periodic scanning of objects, object Ids, or content. For implementations that do not support tagging objects or where impractical, a separate table is maintained to match object identification and timestamps. The absolute time stored for each note may be used in conjunction with the base-time, if one is stored, and possibly modified later, for each section that has a corresponding captured presentation. Notes for presentations that are not captured may still be time stamped to support time-based search, sorting and listing functionality during notes-review after the presentation. At step S720, additional properties may be added to assist in later identification and search operations. For example, the unique section ID, or equivalently the presentation ID, may be added if notes are not stored in hierarchical fashion under sections.

At step S730, the note taker may insert time-stamped iconic indications with predefined meaning anywhere on the page. For example, an iconic symbol that represents “need to review” may be inserted by the student mentioned above. A variety of iconic symbols may be offered for conveying other meanings, including but not limited to “action item,” “important,” “work assigned,” “further research,” and “missed portion.” For additional flexibility, note takers may be allowed to assign their own meanings to a subset of iconic indication symbols. After the presentation this facilitates locating points that were not well understood during the presentation and that therefore require review. For example, FIG. 3 shows an iconic indication 310 depicted by a flag inserted by a note taker to specify a point that merits further study. In this case, the note taker explicitly wrote alongside the indication a reminder to “study modula” (the modula operator). Multiple such types of indications may be predefined, and the list of these indication types, icons and their meanings may be customized using commonplace user interfaces and data structures. In addition, an inserted iconic indication may be associated with one or more notes that the note taker selects. This allows the note taker to insert private bookmarks on selected notes for use in later review. The insertion of icons and associating them with notes may be implemented in a straightforward manner in the notes module with user interface techniques that are well known to those who are skilled in the art. These techniques include, but are not limited to, object insertion (as discussed above) and storing tags or a table with the appropriate association of object identifiers. The iconic indication may be given a fixed visual appearance at its insertion point on a notebook page. Iconic indications of the private-bookmark variety can instead be shown temporarily as a visual icon when an associated note is selected or highlighted by the note taker or automatically during notes-review as described later. Another option allows automatically assigning a private bookmark to each object acquired from the material published by the presenter. For example, if the presenter published a collection of slides, and these are inserted by the note taker, this option may assist the note taker in a later review of the presentation.

At step S740, the note taker, having appropriate network connectivity, may insert time-stamped dynamic presentation objects to his notebook. A dynamic presentation object is selected and inserted any other material from a known online location. It may be, for example simply be the link pre-published by the presenter for online viewing (described above). Unlike static objects, such as images or text, the dynamic presentation object represents a dynamically changing view of the presentation, which continues to change while embedded in the note taker's notebook. The specific content of this view varies based on the presentation capture technology, but in general it contains changing multimedia content. This may be implemented, for example using technologies such as ActiveX, COM and plug-ins along with programmatic interfaces that could be standardized for communication between such embeddable components and presentation capture applications.

In an embodiment of this invention, the presenter uses a TSA to capture the dynamic presentation objects. In this case the visible appearance of the dynamic object includes the current slide, computer-display of the presenter, or snapped images from external cameras, together with annotations the presenter makes on a whiteboard or tablet surface. Optionally, the object may be positioned and resized by the note taker on the notebook page as desired. In this mode the object continues to change as the presenter makes further annotations or when the background changes. However, the invention could be configured to freeze the dynamic object's appearance once the presenter moves on to another distinct multimedia content item. This happens, for example, when the presenter advances to another slide, erases annotations, or switches to another source of visual input e.g. a camera or a computer application. The notes module can communicate with a server component, for example a server 830, or a TSA to obtain the required notifications. The note taker may add notes to this object as to any other, with or without partial or full overlap, both while it is dynamically changing and after it has frozen.

At step S750, it is checked whether the insertion process is complete and, if so, the session ends. Otherwise, execution continues with step S710 any order of insertion is possible, and the order shown is for illustration purposes only. Moreover, not all types of insertions are necessary, for example, only notes or only objects can also be provided by the user of the system without departing from the scope of the invention.

It should be emphasized that various options may be added based on the method discussed above. Specifically, the note taker may choose the dynamic presentation objects or static objects of the type he could have manually inserted before the presentation is auto-inserted e.g. on a new notebook page, as the presenter advances through the sequence of multimedia content used throughout the presentation. As a simple example, when using a slide presentation each slide is automatically inserted in the note taker's notebook as the presenter displays it. The note taker then adds notes to it, and if the object is of the dynamic type, then annotation by the presenter or slide buildups appear as they are made. Another option is to allow note takers to freeze dynamic presentation objects manually whenever the note taker chooses to do so, in addition or instead of using the auto-freeze option described above.

Another option is to allow automatic insertion of a special type of iconic indication referred to as a presenter bookmark whenever the presenter advances to the next in the sequence of multimedia content elements. In the above example, when the presenter advances slides, such bookmark indications are automatically inserted in a note taker's notebook, in addition to other multimedia objects that are inserted as well. Presenter bookmarks are useful during notes review.

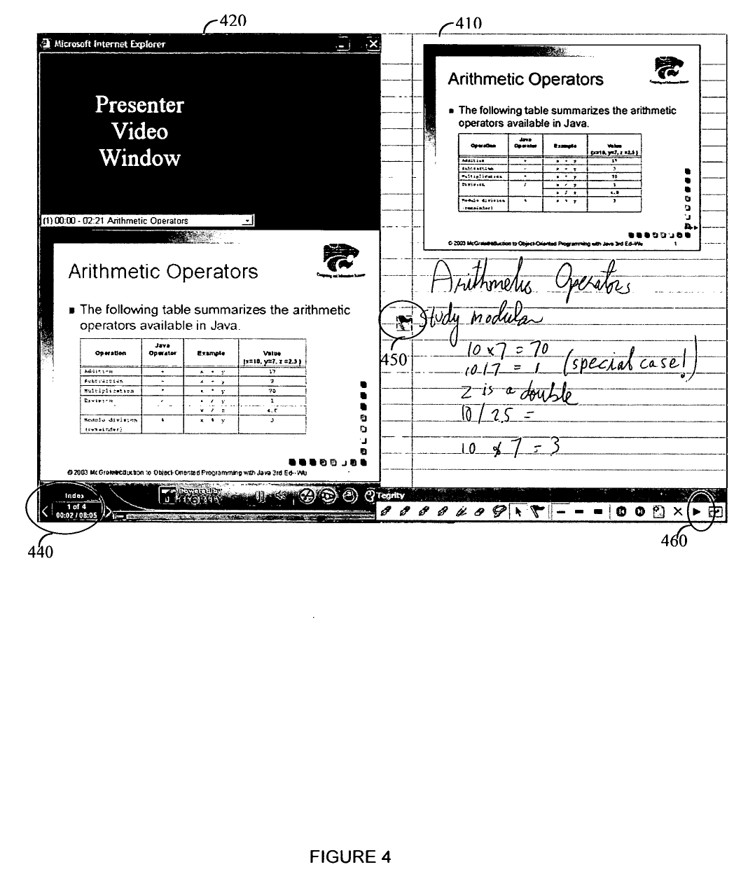

Further to the above, a participant that has network connectivity might perform the above actions while also viewing the presentation concurrently in a separate viewer application. This is especially useful for remote participants. FIG. 4 shows an example of a notebook application in section 410 together with a presentation viewing application 420. The content is displayed at time 00:02. An advanced application of this mode is based on synchronous collaboration tools offered by many prior-art presentation tools. This is best described by an example. In this example the presenter, an instructor, writes out a math problem while a participant Joan views the presentation perhaps remotely, using a presentation viewing tool. In addition, Joan has dragged a dynamic presentation object into her notebook where the instructor's writing also appears, in addition to the viewing tool and the private notes that Joan has written over this object. The instructor then requests that Joan solve the problem for the class and, using facilities of the presentation tools, temporarily makes Joan the presenter. Now Joan writes the solution in the viewing tool and, while doing so, the writing also appears in the dynamic object within her notebook and, presumably, on the displays of other concurrent viewers and in the recorded media. Afterwards, the instructor takes back presenter privileges and clears the page, which may automatically freeze the appearance of the dynamic object that Joan has in her notebook. The display of this object within the notebook now includes the problem as written by the instructor, the solution as written by Joan in the role of temporary presenter, and additional private notes that Joan has written, e.g. “special case!” A variant of this, in which the implementation of the embedded dynamic object is enhanced with synchronous collaboration capabilities, allows Joan to solve the math problem directly in her notebook, rather than in the separate viewer application. While Joan has presenter privileges her new notes are made public, i.e. broadcast to other participants, while at other times they are private and stored only in her computer. Given software components that cooperate using a shared programmable interface, the implementation of this scenario is straightforward.

Given limited display space, various options may be offered to conserve space when the note taker uses a presentation viewing tool concurrently with the notebook application. The window displaying the notebook application could automatically be resized to fit in the remaining display space. When a dynamic presentation object, which is presumably large, is concurrently active in the notebook, the viewing tool could automatically be minimized much of its content is superfluous at that time. Alternatively, the dynamic presentation object could be temporarily replaced with an iconic representation thereof for as long as the viewing tool is synchronously operating and displayed. Once frozen, the object would be restored to its full size. These options save display space while slightly impinging on the note taker's viewing or note-taking abilities. These tasks are accomplished in the notes module and/or the presentation viewing tool with commonly used interfaces for manipulation of display windows and object visibility, size, or format within the notebook application.

Note takers may use note-taking devices such as the Pegasus Mobile Note Taker® to capture their notes in digital form while using ordinary ink on a paper notebook. The device is capable of storing the positions of points that comprise strokes of ink as they are drawn on paper along with the associated time-stamps, which can later be used to link the stored notes to the presentation. In addition, such a device may store events, such as clicking on virtual buttons, provided by sensitive areas on the device itself or predefined areas in its sensing region, which may be activated by the pen or by alternate means. These events along with their associated time-stamps can be used to implement the features of iconic indications and private bookmarks as described above. This is accomplished by importing the stored notes and events at some later time, or as they are generated into the notebook application while converting the stored data to the internal representation used for the corresponding elements, e.g. notes, iconic indications, etc.

All of the above may be done by participants that are physically located at the site of the presentation event, as well as by participants at various remote locations. The remote participants may view or listen to the presentation by any means of communication, whether computer-based, such as using a TSA. For example, an employee may listen to a meeting from home over the telephone while jotting down notes in a notebook. If he has network connectivity, he might insert a dynamic presentation object showing the current slide along with comments and slide “buildups” that his manager adds to the display as the meeting progresses. When moving on to the next topic and slide, the object's appearance freezes, and the employee could choose to insert a new dynamic object elsewhere in his notebook.

Following is a detailed example for processing and reviewing notes after a presentation. Notes are useful in review after the presentation. An important benefit of the current invention is achieved when reviewing notes for recorded presentations that are accessible to the note taker's computer, either online or on local media. The following describes post-presentation capabilities that can be supported by the invention for such presentations.

Asynchronous note capture. The note taker may insert new notes and iconic indications into a notebook. This operates in a similar manner as during the presentation, but lacks support for functions that are based on synchronous operation e.g. dynamic presentation objects. In this mode, new notes are assigned a timestamp that corresponds to the relative time within the presentation as determined by the current playback position. By inserting these notes in the time-frame of the presentation they behave as if they were created during the presentation for the functions described herein. This is accomplished as with notes that are created during the presentation, with a difference being that the notes module communicates with the presentation viewing tool to obtain the current playback time for use in calculating the timestamp to be stored with the notes. In addition, such notes may be specially tagged as review notes, which can be useful for advanced note searching, listing, or sorting functions. Notes added to a presentation's notebook section while the presentation is not being played back are similar to notes added to it before the presentation took place. They may be assigned to the presentation's start time or any time outside the time-frame of the presentation. If such notes can be identified within the notebook section of an existing presentation they are still associated with that presentation.

Indexed playback. The note taker may review notes asynchronously. Where desired, he may select a note, an iconic indication, e.g. private bookmark or presenter bookmark, or any inserted object that is associated with a presentation timestamp. By clicking a button, using a pen gesture, or by some other user-interface element, activate instant playback of the appropriate recorded presentation from the point at which the note was entered. This automatically opens the corresponding viewing tool with the appropriate media for that presentation, positions playback to the correct relative time within the presentation, and begins playback.

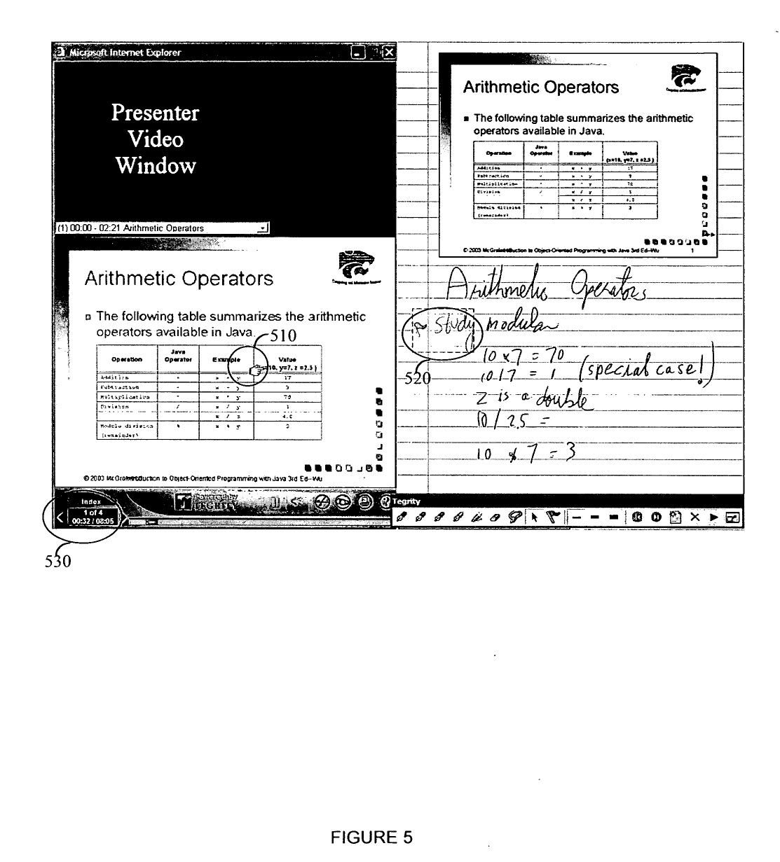

FIG. 4 and FIG. 5 depict an example of indexed playback. FIG. 4 shows both the notebook and viewing applications after the iconic indication (the flag) 450 has been selected by the note taker. This selection is made when the viewing application is already running and displaying the first few seconds of the presentation, as indicated by the time 0:02 shown in section 440. After the note taker clicked the “play” button 460 the viewer application, as shown FIG. 5, is automatically positioned to time 0:32 as shown in section 530 and proceeds to playback the presentation from there. This is the point in the presentation during which the note taker had originally inserted the iconic indication. An iconic “hand” 510 can be seen over the slide image indicating where the instructor was pointing at that time. Audio, video, presenter annotations, and other data streams proceed to playback continuously from this point as well.

Notes for a presentation that do not have a timestamp in the time-frame of the presentation might optionally playback from the beginning of the recorded presentation or open the viewing tool in a paused state. This may include notes made within the notebook section associated with the presentation prior to the presentation and notes made after it without presentation playback. Indexed playback is not available on notes unassociated with recorded presentations. This can be indicated and enforced by hiding or disabling the activation button 460 or other user-interface element if it is always visible, or using a button or element that dynamically appears only when playable notes are selected. Rather than, or in addition to, using the note's timestamp to determine the playback point, the latter may be determined by using a time that is n seconds earlier or the start of the previous presenter-bookmark, the later of the two, or other logic that considers the timestamps and captured objects. The user may be allowed to modify the value of n or other aspects of the logic in this case. Playback times may be calculated on the fly or taken from a pre-computed table with entries for each playable object, is especially useful when complex logic is used to determine optimal playback time.

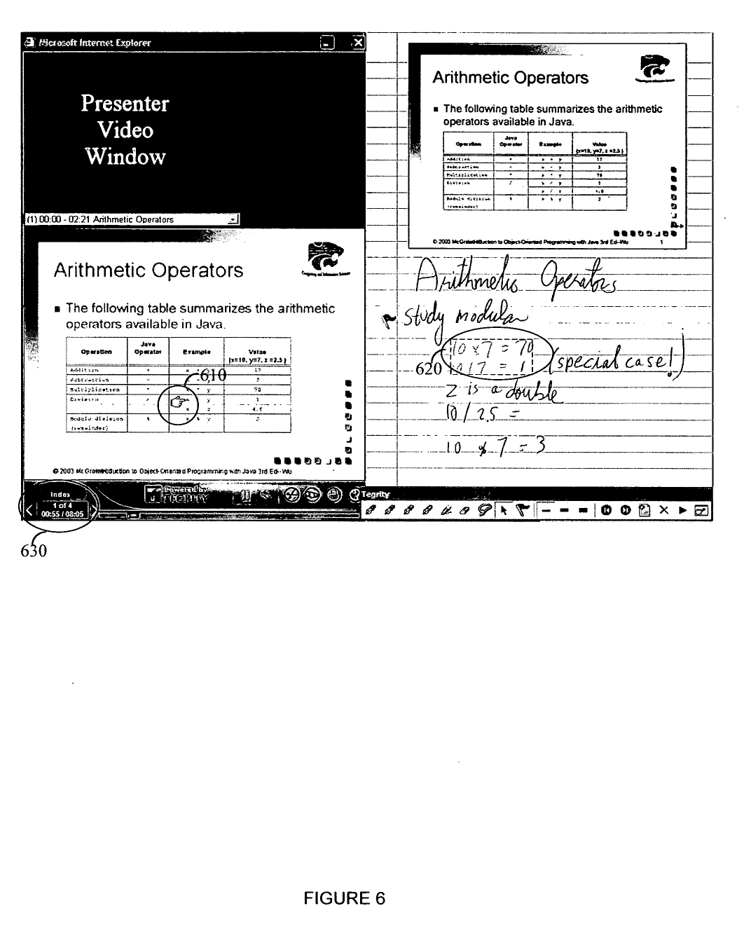

Note highlighting. When playing back recorded presentations or any portions thereof with the associated viewing tool, the current note, if any, may be highlighted by displaying it as selected or by varying one or more of its formatting attributes. The current note is defined as the latest note or other object created on or before the relative presentation time corresponding to the current playback time. The notebook application in FIG. 5 shows in section 520 how the iconic indication (the flag) and an adjacent note (“study”) are highlighted during the playback at time 0:32 that resulted, in this case, from indexed playback of the selected icon as described above. FIG. 6 shows the change that occurs 23 seconds later, i.e. at time 0:55 (shown in section 630). As seen in this example, the highlighted appearance shifts from one note, displayed in section 520 of FIG. 5, to the next note, displayed in section 620 of FIG. 6 to match the timing and order in which the notes are created with respect to the presentation either as it was given or during review.

Note-highlighting uses the same logic as for indexed playback, whereby highlighting may occur a certain modifiable number of seconds prior to or after the actual timestamp or with consideration of bookmark times. Normally, one note is highlighted at a time, although it is not difficult to allow a specific number of notes to remain highlighted simultaneously, for example the previous, current and next note perhaps with different formatting for each, such as fade-in and fade-out or all notes within a specific duration, for example, the past five minutes. A time limit may also be set to turn off highlighting of a note once the time limit expires. Turning off highlighting causes a note to resume its former appearance. A variant of this feature allows replaying the note-taking activity. The notebook section could be shown empty when starting presentation playback, and subsequently, each note appears in it at the relative time corresponding to when it was written. Navigating the viewing tool to a different point in the presentation causes the notebook appearance to change to reflect all notes that appear at the corresponding time. These options could be implemented by the notes module, which communicates with the viewing tool to obtain the current playback time and match it with a pre-computed table, sorted by time, with entries for each note or object that may be highlighted.

Iconic indications. The note taker may request a summarized listing of the iconic indications in the notebook or a section thereof. If multiple types of indications are defined, this may apply to a selected one or subset of types. Indications may also be selected by time range. A list of results are presented, showing the context of the iconic indication as a thumbnail image of the page or area in the notebook or a slice of the page. The display may also show the relative time within the presentation, as well as other pertinent details that may have been stored by the notebook application for the presentation, such as its title, name of presenter, etc. The display also shows the iconic indication for each entry. The note taker clicks on this to activate instant playback of the appropriate recorded presentation from the required point as described above for indexed playback. The notes module performs the tasks of searching and displaying, perhaps assisted by stored tables of indications, including timestamps, type, notebook section, position (page), etc.

Private notes indication. The presentation viewing tool may offer the ability of viewing a summary index of a recorded presentation. This may include thumbnails images of the presenter's slides, for example, or other summary information. When showing this display to each note taker it also provides visual indication of portions of the presentation for which the note taker has notes in his notebook. Specifically, the index-view of a TSA shows a small thumbnail image for each presenter bookmark, which corresponds to a portion of the presentation, and allows playback thereof. With respect to each of these portions for which the note taker has notes, the thumbnail image contains a small distinctive indication, either a special mark or other visual formatting element. This assists the note taker in searching for notes within the presentation and accessing them. A TSA can obtain the necessary information to implement this by communicating with the notes module. In a similar fashion, other displays and lists may be enhanced with information about existence of notes, provided the appropriate programmatic interfaces are added to support this. For example, an organizational LMS, or the likes thereof, could integrate such information into the displays that it provides.

Time adjustment. In some scenarios, as described earlier, there may be improper synchronization between notes and the corresponding viewable presentation media. The note taker may be offered a user-interface to adjust the base-time for a notebook section corresponding to a recorded presentation. The user interface could be a slider that may be used while playing back the presentation recording to correct obvious timing mismatches. Alternatively, an edit box may be offered to enter a date-time or time offset value to apply. Another option is to allow the user to select a note while playing back the presentation and let him activate a set time function which modifies that note's time to correspond to the current playback position and shifts all other notes' timestamps accordingly. The implementation of these is straightforward and relies on using a single base or offset time per notebook section to be used in all time calculations, as described earlier.

Note copy. Copying notes within the notebook application or from one notebook application to another retains the added properties that support the capabilities of the invention. To support interaction with external applications, including other implementations of notebook applications may necessitate using options for importing and exporting note data while performing appropriate format conversions. A specific example of this involves support for devices that do not run full-fledged notebook applications. Some handheld devices may require development of special-purpose note-taking applications with only a subset of the functionality described above. Import and export functions allow data to be exchanged with such devices. For example, a note taker may maintain a fully functional notebook application on a computer at home but attend classes or meetings with a handheld device of limited functionality. The handheld device could be loaded with pre-presentation information from the home computer and presentation-time data could subsequently be transferred back to the home computer, where the user would use the post-presentation reviewing functionality. As another example, this note taker's home computer may not have a notebook application at all. Yet this note taker may still want to benefit from the material published prior to the presentation while using a handheld device. In this case a separate tool is provided to perform the acquisition of published material and export it to the handheld device. These operations can be implemented using data processing techniques commonly known in conventional programming.

Various additional functions may be added as conveniences to the note taker e.g. for adjusting settings and operational parameters or entering, modifying and manipulating attributes and other data. These features are straightforward to implement within the context of the invention.

The values in the text and figures are exemplary only and are not meant to limit the invention. Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. An apparatus for synchronized note taking comprising:
means for providing a presentation to at least one note taker;
means for allowing a note taker to note said presentation by time-tagging said relative to said presentation; and
means for synchronizing a presentation clock and a note taker's computer clock;
wherein off-line, time related access to said presentation and said notes is provided to said note taker.

2. The apparatus of claim 1, wherein said presentation comprises any of:
presentation audio, video, slides, notes, images, computer applications, pointing position, references to electronically accessible textbooks, articles, and internet resources.

3. The apparatus of claim 1, wherein said note comprises and of:
iconic objects, text, drawing, imported slides, and multimedia objects.

4. The apparatus of claim 3, wherein said iconic object comprises:
a predefined call for action.

5. The apparatus of claim 4, wherein said call for action comprises any of the following:
review notes, action item, important, work assigned, further research, and missed portion.

6. The apparatus of claim 1, wherein said means for synchronizing a clock comprises:
means for checking if an elapsed time since a last synchronization with a reference clock of a time server is greater than a predefined time period;
means for synchronizing said presentation clock to a reference clock of said time server if said predefined time period has been exceeded; and
means for keeping a time record for internal synchronization of said presentation clock to said reference clock of said time server while off-line.

7. The apparatus of claim 1, wherein said notes are taken in respect of said presentation at any of:
prior to presenting said presentation, during said presentation and, subsequent to said presentation.

8. The apparatus of claim 1, further comprising:
means for said note taker is capable of reviewing said presentations and said notes in a synchronized manner.

9. The apparatus of claim 8, said means for reviewing in said synchronized manner comprising:
means for beginning review in respect of a first time stamp at least one of a specified amount of time prior to said first time stamp, at said first time stamp, and a specified amount of time after said first time stamp.

10. The apparatus of claim 9, said means for reviewing in said synchronized manner comprises:
means for highlighting said notes in respect of a first time stamp at at least one of a specified amount of time prior to said first time stamp, at said first time stamp, and a specified amount of time after said first time stamp.

11. The apparatus of claim 7, wherein said notes comprise:
presentation dynamic objects.

12. The apparatus of claim 10, further comprising:
means for said note taker viewing any update of said dynamic presentation objects may be viewed by said note taker.

13. The apparatus of claim 12, wherein said dynamic presentation objects may be viewed by other note takers.

13. The apparatus of claim 7, further comprising:
means for searching said notes may be searched by said time-tags.

14. The apparatus of claim 1, wherein said means for synchronizing presentations clock comprise:
means for connecting to a time server;
means for retrieving reference clock information from said time server; and
means for maintaining a plurality of time values to enable synchronization between said presentation clock and at least said reference clock.

16. A computer software program started in a tangible medium and provided for synchronized note taking regardless of whether said computer is on-line or off-line, said computer software containing commands capable of performing the steps of:
periodically synchronizing a presentation clock and a note taker's clock to a reference clock, thereby enabling a note taker to take notes in an off-line mode;
enabling insertion of notes by said note taker into a note taking application, said notes being time-tagged to said note taker's clock; and
enabling off-line review of said notes in synchronization with a presentation.

17. The computer software program of claim 16, wherein said periodic synchronizing comprises the steps of:
checking if an elapsed time since a last synchronization with a reference clock of a time server is greater than a predefined time period;
synchronizing said note taker's clock to a reference clock of said time server if said predefined time period has been exceeded; and
keeping a time record of internal synchronization of said note taker's clock to said reference clock of said time server while off-line.

18. The computer software program of claim 17, wherein said presentation comprises any of:
audio, video, slides, notes, images, computer applications, pointing position, references to electronically accessible textbooks, articles, and internet resources.

19. The computer software program of claim 16, wherein said notes comprise any of:
iconic objects, text, drawing, imported slides, and multimedia objects.

20. The computer software program of claim 19, wherein said iconic object comprises:
a predefined call-for-action.

21. The computer software program of claim 20, wherein said call-for-action comprises any of the following:
review notes, action item, important, work assigned, further research, missed portion.

22. The computer software program of claim 16, wherein said review of said notes further comprises the step of:
enabling search of said annotations based at least on said time tags.

23. The computer software program of claim 16, wherein said review of said notes in synchronization with a presentation further comprises the step of:
reviewing a first time stamp at least one of a specified amount of time prior to said first time stamp, at said first time stamp, and a specified amount of time after said first time stamp.

24. The computer software program of claim 16, wherein said review of said notes in synchronization with a presentation further comprises the step of:
highlighting said notes in respect of a first time stamp at any of: a specified amount of time prior to said first time stamp, at said first time stamp, and a specified amount of time after said first time stamp.

25. A method for synchronized note taking regardless of whether a note taker's computer is on-line or off-line, said method comprising the steps of:
periodically synchronizing a presentation clock and a note taker's clock to a reference clock, thereby enabling a note taker to make notes in an off-line mode;
enabling insertion of notes by said note taker into a note taking application, said notes being time-tagged to said note taker's clock; and
enabling off-line review of said notes in synchronization with a presentation.

26. The method of claim 25, wherein said periodic synchronizing comprises the steps of:
checking if an elapsed time since a last synchronization with a reference clock of a time server is greater than a predefined time period;
synchronizing said note taker's clock to a reference clock of said time server if said predefined time period has been exceeded; and
keeping a time record for internal synchronization of said note taker's clock to said reference clock of the time server while off-line.

27. The method of claim 26, wherein said presentation comprises any of:
audio, video, slides, notes, images, computer applications, pointing position, references to electronically accessible textbooks, articles, and internet resources.

28. The method of claim 25, wherein said notes comprise any of:
iconic objects, text, drawings, imported slides, multimedia objects.

29. The method of claim 29, wherein said iconic object comprises:
a predefined call-for-action.

30. The method of claim 29, wherein said call-for-action comprises any of the following:
review notes, action item, important, work assigned, further research, and missed portion.

31. The method of claim 25, wherein said review of said notes further comprises the step of:
enabling search of said notes based at least on said time tags.

32. The method of claim 25, wherein said review of said notes in synchronization with said presentation further comprises the step of:
reviewing a first time stamp at at least any of a specified amount of time prior to said first time stamp, at said first time stamp, and a specified amount of time after said first time stamp.

33. The method of claim 25, wherein said review of said notes in synchronization with said presentation further comprises the step of:
highlighting said notes for a first time stamp at at least: a specified amount of time prior to said first time stamp, at said first time stamp, and a specified amount of time after said first time stamp.

34. A note taking system configured for the purpose of synchronized note taking regardless whether said note taking system is on-line or off-line, said note taking system comprising:
means for digitally taking and storing notes;
means for associating one or more a time-tags with any or all notes taken; and
means for periodically synchronizing a clock of said note taking system to a reference clock of a time server, and for maintaining such synchronization while said note taking system is off-line.
